(19) United States
(12) Patent Application Publication
(10) Pub. No.: US 2003/0137157 A1
(43) Pub. Date: Jul. 24, 2003

(54) Bandana doggie pooh bag

(76) Inventor: Kenneth C. Hopkins, Ft Collins, CO (US)

Correspondence Address: Kenneth Hopkins, 1421 N Taft Hill Rd, Ft Collins, CO, 80521, US

(21) Appl. No.: 10/345,298

(22) Filed: Jan. 15, 2003

Related U.S. Application Data
(60) Provisional application No. 60/349,452, filed on Jan. 18, 2002.

(51) Int. Cl. A01K 29/00; E01H 1/12

(52) U.S. Cl. 294/1.3

(57) ABSTRACT

A pet fecal collection and disposal system which allows a fashionable piece of clothing than can be used as a pet waste collection bag. A bandana shaped bag is fabricated form two layers of a flexible non-porous or bio-degradable material. The bandana doggie bag is worn around your pet's neck as would any bandana or handkerchief like a piece of pet clothing. When needed the bandana can be untied and used as a collection bag. Insert hand into the bag, grasp article, turn inside out, tie up long ends and dispose. The bag can be fabricated from many different materials and be different shapes, sizes and patterns. The invention provides an easy means to remember to bring along a fashionable yet functional pet waste collection and disposal system.

### BACKGROUND OF THE INVENTION

This invention relates to pet fecal collection and disposal systems, especially to the bags used to collect pet waste.

### PRIOR ART

Pet owners are generally subject to regulations requiring them to pick up and dispose of their pet waste. Numerous bag like expedients have been designed for collecting of pet waste. Pet stores normally carry several types of pet waste bags, usually a square or rectangle shaped bag or a bag outlined or shaped like a glove. Some have extra flaps or double linings, but none are easy to remember to bring along on walks when the occasion may arise for using a pet waste collection bag. Some bags get taken along and not used and thrown away because they are not convenient. These bags are more nuisance than useful. Because of these shortcomings, widespread use of pet waste collection bags have not gotten overwhelming acceptance.

### SUMMARY

This invention provides an easy way to remember to bring along a pet waste collection bag. Bandanas are regularity worn by pets as a fashionable piece of pet clothing. My invention incorporates a useful pet waste collection bag fabricated into the shape of a bandana. It is easy to remember to put a colorful bandana on your pet. Now you also have easy access to a useful pet waste collection bag.

Accordingly, several objects and advantages of my invention are:

(a) to provide a pet waste collection system that would easy to remember to bring along.

(b) to provide a pet waste collection system that can be flexible and brightly colored.

(c) to provide a pet waste collection system that can be colored several colors.

(d) to provide a pet waste collection system that can be manufactured from bio-degradable materials to help reduce space in landfills.

(e) to provide a pet waste collection system that is a fashionable piece of pet clothing.

(f) to provide widespread acceptance of using a pet waste collection bag.

(g) to provide better stewardship through the use of pet waste collection systems.

(h) to help provide more sanitary parks and lawns.

Still further objects and advantages will become apparent from the consideration of the description and drawings.

### DESCRIPTION OF THE DRAWINGS

FIG. 1 shows a perspective front view of my invention.

FIG. 2 is a view showing the top view.

### REFERENCES NUMERALS IN DRAWINGS

10 front side of bag

20 rear side of bag

30 unsealed portion of top edge

40 sealed portion of all other sides

50 stiffing tabs

### DESCRIPTION OF PREFERRED EMBODIMENTS

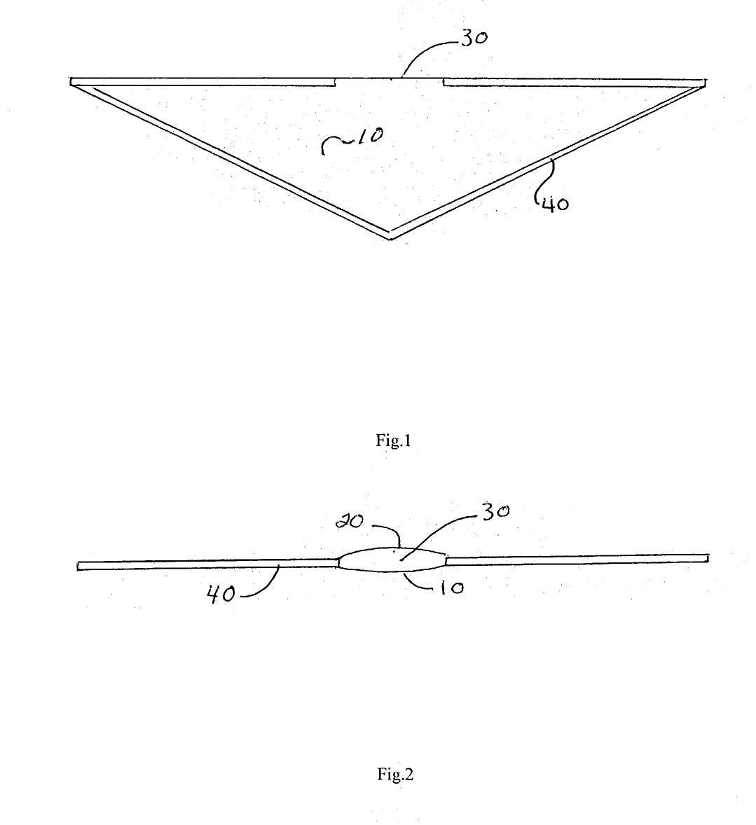

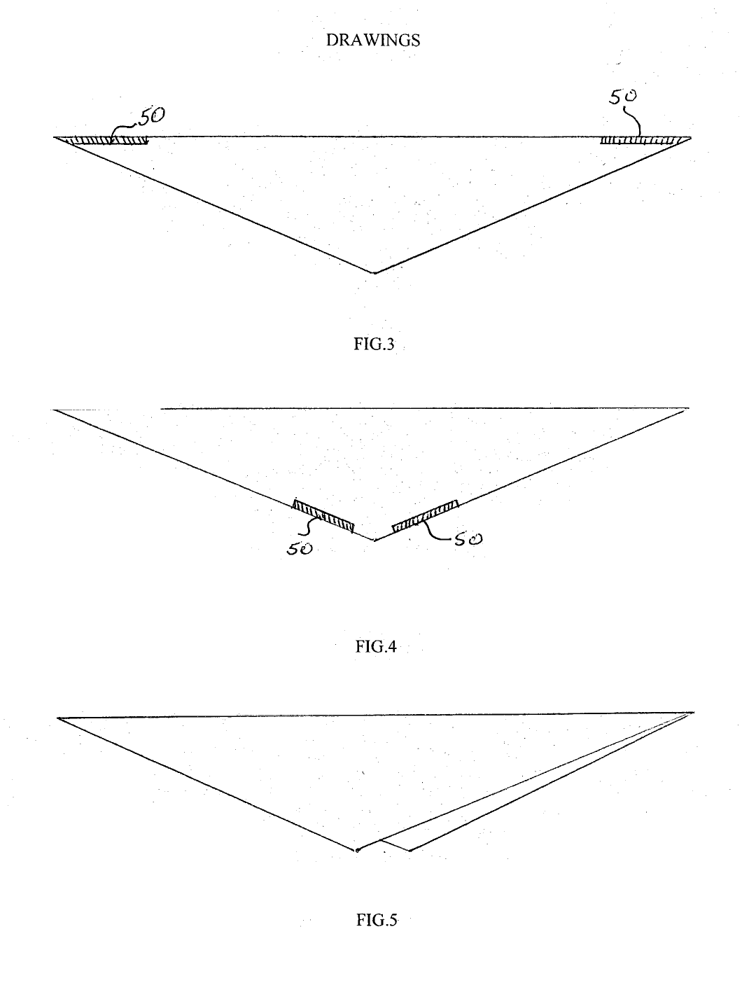

A preferred embodiment of the present invention is illustrated in FIG. 1 front view and FIG. 2 top view. Two layers of non-porous or bio-degradable material laid together one on top of the other. These sheets represent the front 10 and the back 20 sides of my invention. A sealing machine would seal edges 40 along all sides except a portion 30 along the top edge. This portion would remain open to facilitate collecting pet waste. The ears of the bandana doggie pooh bag can be tied together to make a very convenient, easy to dispose of, pet waste collection system. Front 10 side of bandana doggie pooh bag can be printed with many patterns and colors. Rear 20 side of bag can be printed with valuable information. Having each side separate would make changing patterns or information easier and less costly.

Operation of Main Embodiment

The manner of using the bandana doggie pooh bag is almost identical to that of other pet collection bags. Namely, one sticks their hand inside bag, grasp material, turn inside out, tie up ends and dispose.

The difference is that my invention is of different shape, which lends itself to become a fashionable piece of pet clothing. Pet owners quite often dress up their pet with a bandana and with numerous patterns and colors for all occasions my bandana doggie pooh bag will surely become a regular piece of pet clothing. This makes it a lot easier to remember to bring along as it is already on your pet. The bandana doggie pooh bag is ready for business whether it is for fashion or for function. The shape of the bandana doggie bag allows the bag to be tied more securely than folding a flap. This makes for a much more secure, compact, and convenient pet waste collection system.

Alternative Embodiments

Additional embodiments are shown in FIGS. 3,4, in each case the stiffing tabs 50 are shown with the standard bandana doggie bag. These stiffening tabs 50 are helpful in scooping pet waste into said bag. In FIG. 3 the stiffening tabs 50 are positioned in the long ears of said bag. FIG. 4 the stiffening tabs 50 are positioned nearer to the center of said bag. FIG. 5 shows alternate shape that can be used to form a bandana doggie pooh bag.

### CONCLUSIONS, RAMIFICATIONS, AND SCOPE.

Accordingly, the reader will see that my bandana doggie pooh bag can be used to collect pet waste in a non-porous or bio-degradable collection bag easily used and conveniently disposal. In addition, my bandana doggie bag is a very fashionable piece of pet clothing. Furthermore, the bandana doggie bag has addition advantages.

(a) it permits the production of various designs and information without expensive retooling by using separate front and back patterns printed on rolls.

(b) it promotes a superior way to collect pet waste.

(c) it promotes more widespread use of collection bags.

(d) it promotes more sanitary lawns and parks.

(e) it makes remembering to bring along a collection bag easier.

Although the description above contains many specifications, these should not be construed as limiting the scope of the invention but as merely providing illustrations of some of the presently preferred of this invention. For example, the bandana doggie pooh bag can have other sizes or shapes.

References Cited
U.S. Patent Documents

| | | | |
|---|---|---|---|
| 4290386 | Sep., 1981 | Eiriksson | 119/868 |
| 4645251 | Feb., 1987 | Jacobs | 294/1.3 |
| 5568955 | Oct., 1996 | Giuliano | 294/1.3 |
| 5704670 | Jan., 1998 | Surplus | 294/25 |
| 6102457 | Aug., 2000 | Smith | 294/1.3 |

I claim:

1. A pet fecal collection and disposal system, comprising;
a bag formed of a flexible material having sufficient size and triangular in shape to accommodate use by pets and pet owners.
a plurality of elongated ends of the bag and functions to encircle a pet neck and secure bag to pet.
an opening along upper edge of said bag allows reclamation of pet waste, whereby said bag is a piece of pet clothing and a pet waste collection bag.
